(19) United States
(12) Patent Application Publication
(10) Pub. No.: US 2008/0070061 A1
(43) Pub. Date: Mar. 20, 2008

(54) HIGH-TEMPERATURE COATINGS AND BULK ALLOYS WITH PT METAL MODIFIED GAMMA-NI +GAMMA'-NI3AL ALLOYS HAVING HOT-CORROSION RESISTANCE

(75) Inventors: Brian GLEESON, Ames, IA (US); Daniel J. Sordelet, Ames, IA (US)

Correspondence Address: OBLON, SPIVAK, MCCLELLAND MAIER & NEUSTADT, P.C., 1940 DUKE STREET, ALEXANDRIA, VA, 22314, US

(73) Assignee: Iowa State University Research Foundation, Inc., Ames, IA (US)

(21) Appl. No.: 11/744,653

(22) Filed: May 4, 2007

Related U.S. Application Data
(63) Continuation of application No. 11/206,663, filed on Aug. 18, 2005.
(60) Provisional application No. 60/602,714, filed on Aug. 18, 2004.

(51) Int. Cl. B32B 15/01; B32B 15/04; C22C 19/03; C22C 19/05

(52) U.S. Cl. 428/680; 420/442; 420/456; 428/457

(57) ABSTRACT

An alloy including a Pt-group metal, Ni and Al, wherein the concentration of Al is limited with respect to the concentration of Ni and the Pt-group metal such that the alloy includes substantiailly no β-NiAl phase, and wherein the Pt-group metal is present in an amount sufficient to provide enhanced hot corrosion resistance.

This application claims priority from U.S. Provisional Application Ser. No. 60/602,714 filed Aug. 18, 2004, the contents being incorporated herein by reference.

### STATEMENT REGARDING FEDERALLY SPONSORED RESEARCH AND DEVELOPMENT

The U.S. Government has a paid-up license in this invention and the right in limited circumstances to require the patent owner to license others on reasonable terms as provided by the terms of Contract Nos. N00014-04-1-0368 and N00014-02-1-0733, each awarded by the Office of Naval Research.

### TECHNICAL FIELD

This invention relates to alloys that are resistant to degradation at high temperatures by oxidation and hot corrosion processes. The alloy compositions may be used in bulk form or as a coating.

### BACKGROUND

To enhance reliable and long-term operation of gas turbine engines at varying high temperatures and under highly corrosive conditions, high-temperature turbine component materials, typically γ-Ni+γ′-Ni₃Al nickel-base superalloys, are coated with a thermal barrier coating that is highly resistant to oxidation and corrosion. The thermal barrier coating typically includes an oxidation and corrosion resistant alloy coating on the superalloy substrate, and a ceramic topcoat may optionally be applied over the corrosion resistant alloy coating. Ideally, the oxidation and corrosion resistance of the thermal barrier coating is provided by a thermally grown oxide (TGO) scale of Al₂O₃, which forms on the corrosion resistant alloy coating.

Hot corrosion is an accelerated degradation process in which corrosive species (e.g., sulfates) are deposited from the surrounding environment (e.g., combustion gas) to the surface of hot components, followed by destruction of the protective TGO scale. Gas turbine engine components exposed to marine environments are apt to encounter two modes of hot corrosion: high temperature hot corrosion (Type I) in the temperature range 850-1000° C. and low temperature hot corrosion (Type II) in the range 600-800° C.

The commonly used β-NiAl-alloy based coatings applied to superalloy substrates are excellent Al₂O₃-scale formers. However, the resistance of such β-NiAl based coatings to accelerated attack by molten-salt induced hot corrosion is rather poor. The hot-corrosion resistance of β-based alloy coatings can be improved by chromium or silicon addition, but invariably at the expense of oxidation resistance.

U.S. Publication Number 2004/0229075 A1, incorporated herein by reference, describes an alloy including a Pt-group metal, Ni and Al in relative concentration to provide a γ+γ′ phase constitution, where γ refers to the solid-solution Ni phase and γ′ refers to the solid-solution Ni₃Al phase. This alloy includes a Pt-group metal, Ni and Al, wherein the concentration of Al is limited with respect to the concentration of Ni and the Pt-group metal such that the alloy includes substantially no β-NiAl phase. While the alloys described in U.S. Publication Number 2004/0229075 A1 exhibit good oxidation and hot corrosion resistance, for parts operated under severe conditions alloy coatings are needed to provide excellent long-term resistance to both hot corrosion and high temperature (>900° C.) oxidation. If the coated superalloy substrate is intended for operation in the presence of salt, such as, for example, aero and marine turbine blades, the coating must also be resistant to salt induced hot-corrosion.

### SUMMARY

In one aspect, there is provided in the present application an alloy including a Pt-group metal, Ni and Al, wherein the concentration of Al is limited with respect to the concentration of Ni and the Pt-group metal such that the alloy includes substantially no β-NiAl phase, and wherein the Pt-group metal is present in an amount sufficient to provide at least one of enhanced hot corrosion and oxidation resistance. This alloy or coating composition may optionally include at least one of Cr and Si to further enhance its hot corrosion resistance, while maintaining excellent oxidation resistance. In this application the term “hot corrosion resistance” refers to resistance to any of Type I, Type II or salt induced hot corrosion, and the term “oxidation resistance” refers to resistance to oxidation at any temperature, particularly high temperature oxidation resistance at greater than 900° C.

In another aspect, there is provided an alloy including less than about 23 at % Al, about 3 at % to about 10 at % of a Pt-group metal, and the remainder Ni. This alloy may further include up to about 2 at % of a reactive metal, such as Hf, and may further include constituent metals typically used in a superalloy substrate such as, for example, Cr. This alloy may also include at least one of: (1) up to about 20 at % Cr, and (2) up to about 7 at % Si.

In another aspect, there is provided an alloy including less than about 23 at % Al, about 3 at % to about 20 at % of a Pt-group metal, at least one of: (1) up to about 20 at % Cr, and (2) up to about 7 at % Si; and the remainder Ni. This alloy may further include up to about 2 at % of a reactive metal, preferably Hf.

In yet another aspect, there is provided a coating composition including the oxidation and hot-corrosion resistant alloys described above.

In yet another aspect, there is provided a method for making a heat-resistant substrate or the composition for an overlay-type coating including the oxidation and hot-corrosion resistant compositions above.

In yet another aspect, there is provided a coating including the oxidation and hot-corrosion resistant alloys above.

The Pt-group metal modified alloys of the present invention have a γ-Ni phase and a γ′-Ni₃Al (referred to herein as γ-Ni+γ′-Ni₃Al or γ+γ′) or solely γ′ phase constitution that is both chemically and mechanically compatible with the γ+γ′ microstructure of a typical Ni-based superalloy substrate. The Pt-group metal modified γ+γ′ or γ′ alloys are particularly useful as bond coat layers in TBC systems applied on a superalloy substrate used in a high-temperature resistant mechanical components, but may also be used as overlay coatings for any type of substrate, or as bulk alloys.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a series of plots and related sample photographs showing weight gain of Pt-modified γ and γ′ alloys with and without pre-oxidation.

FIGS. 2A-D is series of cross-sectional SEM images of Pt modified (Ni-22Al—Pt-1 wt % Hf) untreated γ and γ′ alloys with increasing Pt content.

FIGS. 3A-C is a series of cross-sectional SEM images showing formation of Ni₃S₂ in γ and γ′ Ni-22Al—Pt alloys with increasing Pt content.

FIGS. 4A-B is a series of cross-sectional and surface SEM images showing formation of Ni₃S₂ in initial stages of Ni-22Al-30Pt-0.35Hf after 20 hours.

FIG. 5 is a plot showing hot Corrosion resistance of Ni-22Al-20Pt base alloys with increasing Cr content.

FIGS. 6A-D is a series of cross-sectional SEM images of Ni-22Al-20Pt base alloys with increasing Cr content after 100 hours hot corrosion at 900° C.

FIG. 7 is a plot and related sample photographs showing weight gain of Cr-modified Ni-22Al-10Pt—Cr-1 wt % Hf alloys with and without pre-oxidation.

FIGS. 8A-B is a series of cross-sectional SEM images of pre-oxidized Ni-22Al-10Pt—Cr-1 wt % Hf alloys.

FIG. 9 is a plot and related sample photographs showing weight gain of Cr-modified Ni-22Al-5Pt—Cr-1 wt % Hf alloys with and without pre-oxidation.

FIGS. 10A-C is a series of cross-sectional SEM images of Cr-modified and pre-oxidized y and γ′ Ni-22Al-5Pt—Cr-1 wt % Hf alloys.

FIG. 11 is a plot and related sample photographs showing weight gain of Si-modified Ni-22Al—Pt—Si-1 wt % Hf alloys with and without pre-oxidation.

FIGS. 12A-D is a series of cross-sectional SEM images of pre-oxidized Si modified Ni-22Al-10Pt-5Si-1 wt % Hf and Si—Cr modified Ni-22Al-5Si-5Cr-1 wt % Hf alloys.

FIG. 13 is a plot showing weight gain after isothermal oxidation (for 80 hours at 1100° C.) of Ni-22Al—Pt—Cr-1 wt % Hf alloys.

FIG. 14 is a plot and related sample photographs showing weight gain of Cr and Si modified Pt containing γ+γ alloys after 500 cycles of cyclic oxidation.

FIG. 15 is a plot showing weight gain of Cr and Si modified Ni-22Al—Pt-1 wt % Hf alloys compared to Ni-22Al-30Pt-1 wt % Hf and β Ni-50Al-15Pt alloys after 500 cycles of cyclic oxidation.

FIG. 16 is a cross-sectional diagram of a metallic article with a thermal barrier coating.

Like referenced symbols in the various drawings indicate like elements.

### DETAILED DESCRIPTION

In one aspect, there is provided a platinum (Pt) group metal modified γ-Ni+γ′-Ni₃Al or γ′-Ni₃Al alloy, wherein the Pt-group metal is present in an amount sufficient to provide enhanced hot corrosion resistance while maintaining excellent oxidation resistance. The Pt-group modified γ-Ni+γ′-Ni₃Al alloy refers to an alloy including a Pt-group metal, Ni and Al in relative concentration such that a γ-Ni+γ′-Ni₃Al phase constitution results. In this alloy: (1) the concentration of Al is limited with respect to the concentration of Ni and the Pt-group metal such that substantially no β-NiAl phase structure, preferably no β-NiAl phase structure, is present in the alloy and the γ-Ni+γ′-Ni₃Al phase structure predominates; and (2) the concentration of the Pt-group metal is controlled to provide enhanced resistance to hot corrosion.

In this alloy the amount of the Pt-group metal may vary widely depending on the intended application, but typically will be less than about 10 at %. In some embodiments the Pt-group metal is present in an amount of at least about 3 at % and up to about 10 at %, and in other embodiments in an amount of at least about 3 at % and less than about 5 at %. The amount of Al in the alloy is typically less than about 23 at %, preferably about 10 at % to about 22 at %. The at % values specified for all elements in this application are nominal, and may vary by as much as ±1-2 at %.

The Pt-group metal may be selected from, for example, Pt, Pd, Ir, Rh and Ru, or combinations thereof. Pt-group metals including Pt are preferred, and Pt is particularly preferred.

Additional reactive elements such as Hf, Y, La, Ce and Zr, or combinations thereof, may optionally be added to or be present in the hot corrosion resistant Pt-group metal modified γ-Ni+γ′-Ni₃Al alloy to modify and/or improve its properties. The addition of such reactive elements tends to stabilize the γ′ phase. Therefore, if sufficient reactive metal is added to the composition, the resulting phase constitution may be predominately γ′ or solely γ′. Typically the reactive elements may be added to the hot corrosion resistant Pt-group metal modified γ-Ni+γ′-Ni₃Al alloy at a concentration of up to about 2 at % (4 wt %), preferably 0.1 at % to 2 at % (0.2 wt % to 4 wt %), more preferably 0.5 at % to 1 at % (1 wt % to 2 wt %). A preferred reactive element composition includes Hf, and Hf is particularly preferred.

In addition, other typical superalloy substrate constituents such as, for example, Cr, Co, Mo, Ta, and Re, and combinations thereof, may optionally be added to or present in the Pt-group metal modified γ-Ni+γ′-Ni₃Al alloy in any concentration to the extent that a γ+γ′ phase constitution predominates.

The hot-corrosion resistance of this alloy may be further enhanced by the addition of at least one of: (1) up to about 20 at % of Cr; and (2) up to about 7 at % Si. In one embodiment, the Cr constituent of the alloy includes about 3 at % to about 20 at % Cr, or about 5 at % to about 15 at % Cr. The Cr constituents may be present in the alloy alone or in combination with any of the following Si constituents: about 2 at % to about 7 at % Si, or about 3 at % to about 5 at % Si.

In another embodiment, a hot corrosion and oxidation resistant (Pt) group metal modified γ-Ni+γ′-Ni₃Al or γ′-Ni₃Al alloy is provided that includes: (1) up to 25 at % of a Pt-group metal, typically about 3 at % to about 20 at %, or about 3 at % to about 15 at %; or about 10 at % to about 15 at %; (2) less than about 23 at % Al, preferably about 10 at % to about 22 at % Al; (3) up to about 2 at % (4 wt %), preferably 0.1 at % to 2 at % (0.2 wt % to 4 wt %), more preferably 0.5 at % to 1 at % (1 wt % to 2 wt %) of a reactive metal; typically Hf; and (4) at least one of: (i) up to about 20 at % of Cr; and (ii) up to about 7 at % Si; and (5) the remainder Ni. In typical embodiments, the alloy may include any of the following as the Cr constituent of component (4): about 3 at % to about 20 at % Cr, or about 5 at % to about 15 at % Cr. In typical embodiments of component (4), any of the Cr constituents may be used alone or in combination with any of the following: about 2 at % to about 7 at % Si, or about 3 at % to about 5 at % Si. As shown in the working examples below, these materials exhibited excellent cyclic oxidation resistance at elevated temperatures in the range of 1150° C. In most embodiments, the reactive metal is Hf and the Pt-group metal is Pt.

Any of the oxidation and hot corrosion resistant alloys described above may be prepared by conventional techniques such as, for example, argon-arc melting pieces of high-purity Ni, Al, Pt-group metals and optional reactive and/or superalloy constituent metals, Si and combinations thereof.

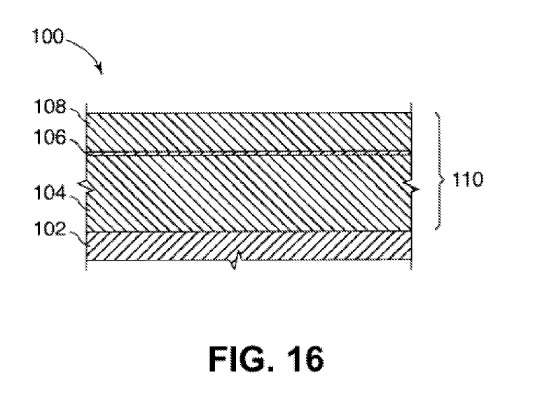

The oxidation and hot corrosion resistant Pt-group metal modified γ-Ni+γ′-Ni₃Al alloys described above may be applied as a coating composition on any substrate to impart high-temperature degradation resistance, oxidation resistance, and hot corrosion resistance to the substrate. Referring to one embodiment shown in FIG. 16, a typical substrate will typically be a Ni or Co-based superalloy substrate 102. Any conventional Ni or Co-based superalloy may be used as the substrate 102, including, for example, those available from Martin-Marietta Corp., Bethesda, Md., under the trade designation MAR-M 002; those available from Cannon-Muskegon Corp., Muskegon, Mich., under the trade designation CMSX-4, CMSX-11, and the like.

The Pt-group metal modified γ-Ni+γ′-Ni₃Al alloy may be applied to the substrate 102 using any known process, including for example, plasma spraying, chemical vapor deposition (CVD), physical vapor deposition (PVD) and sputtering to create a coating 104 and form a temperature/oxidation/corrosion-resistant article 100. Typically this deposition step is performed in an evacuated chamber.

Again referring to FIG. 16, the thickness of the coating 104 may vary widely depending on the intended application, but typically will be about 5 μm to about 100 μm, preferably about 5 μm to about 50 μm, and most preferably about 10 μm to about 50 μm. The composition of the coating 104 may be precisely controlled, and the coating has a substantially homogenous γ+γ′ constitution, which in this application means that the γ+γ′ structure predominates though the coating. In addition, the coating 104 has a substantially constant Pt-group metal concentration throughout.

In some embodiments the coating 104 is a bond coat layer, a layer of ceramic typically consisting of partially stabilized zirconia may then be applied using conventional PVD processes on the bond coat layer 104 to form a ceramic topcoat 108. Suitable ceramic topcoats are available from, for example, Chromalloy Gas Turbine Corp., Delaware, USA. The deposition of the ceramic topcoat layer 108 conventionally takes place in an atmosphere including oxygen and inert gases such as argon. The presence of oxygen during the ceramic deposition process makes it inevitable that a thin oxide scale layer 106 is formed on the surface of the bond coat 104. The thermally grown oxide (TGO) layer 106 includes alumina and is typically an adherent layer of Al₂O₃. The bond coat layer 104, the TGO layer 106 and the ceramic topcoat layer 108 form a thermal barrier coating 110 on the superalloy substrate 102.

The hot corrosion resistant Pt-group metal modified γ-Ni+γ′-Ni₃Al alloys utilized in the bond coat layer 104 are both chemically and mechanically compatible with the γ+γ′ phase constitution of the Ni or Co-based superalloy 102. Protective bond coats formulated from these alloys will have coefficients of thermal expansion (CTE) that are more compatible with the CTEs of Ni-based superalloys than the CTEs of β-NiAl—Pt based alloy bond coats. The former provides enhanced thermal barrier coating stability during the repeated and severe thermal cycles experienced by mechanical components in high-temperature mechanical systems.

When thermally oxidized, the hot corrosion resistant Pt-group metal modified γ-Ni+γ′-Ni₃Al alloy bond coats grow an Al₂O₃ scale layer at a rate comparable to or slower than the thermally grown scale layers produced by conventional β-NiAl—Pt bond coat systems, and this provides excellent oxidation resistance for γ-Ni+γ′-Ni₃Al alloy compositions. The Pt-metal modified γ+γ′ alloys also exhibit much higher solubility for reactive elements such as, for example, Hf, than conventional β-NiAl—Pt alloys, which makes it possible to further tailor the alloy formulation for a particular application. For example, when the hot corrosion resistant Pt-metal modified γ+γ′ alloys are formulated with other reactive elements such as, for example, Hf, and applied on a superalloy substrate as a bond coat, the growth of the TGO scale layer is even slower. After prolonged thermal exposure, the TGO scale layer further appears more planar and has enhanced adhesion on the bond coat layer compared to scale layers formed from conventional β-NiAl—Pt bond coat materials.

In addition, the thermodynamic activity of Al in the Pt-group metal modified γ-Ni+γ′-Ni₃Al alloys can, with sufficient Pt content, decrease to a level below that of the Al in Ni-based superalloy substrates. When such a bond coating including the Pt-group metal modified γ-Ni+γ′-Ni₃Al alloys is applied on a superalloy substrate, this variation in thermodynamic activity causes Al to diffuse up its concentration gradient from the superalloy substrate into the coating. Such “uphill diffusion” reduces and/or substantially eliminates Al depletion from the coating. This reduces spallation in the scale layer, increases the stability of the scale layer, and enhances the service life of the ceramic topcoat in the thermal barrier system.

Thermal barrier coatings with bond coats including the hot corrosion resistant Pt-group metal modified γ-Ni+γ′-Ni₃Al alloys may be applied to any metallic part to provide resistance to severe thermal conditions. Suitable metallic parts include Ni and Co based superalloy components for gas turbines, particularly those used in aeronautical and marine engine applications.

In addition, the hot corrosion resistant Pt-group metal modified 7γNi+γ′-Ni₃Al alloys may be used in bulk alloy form such as, for example, foils, sheets, and the like, to take advantage of the heat, oxidation and hot corrosion resistant properties that the alloys provide.

The alloy and coating compositions disclosed in this invention may be used in an as-fabricated “bare” state or with a “preformed” thermally grown oxide layer on the surface. With regard to the latter, the alloy or coating can be exposed to an oxidizing atmosphere at an elevated temperature so as to cause a reaction leading to the formation of an oxide scale layer. This scale layer will be rich in Al₂O₃.

The oxidation and corrosion resistant alloys will now be described with reference to the following non-limiting examples.

### EXAMPLES

### Example 1

### High Temperature Hot Corrosion (HTHC) (900° C.)

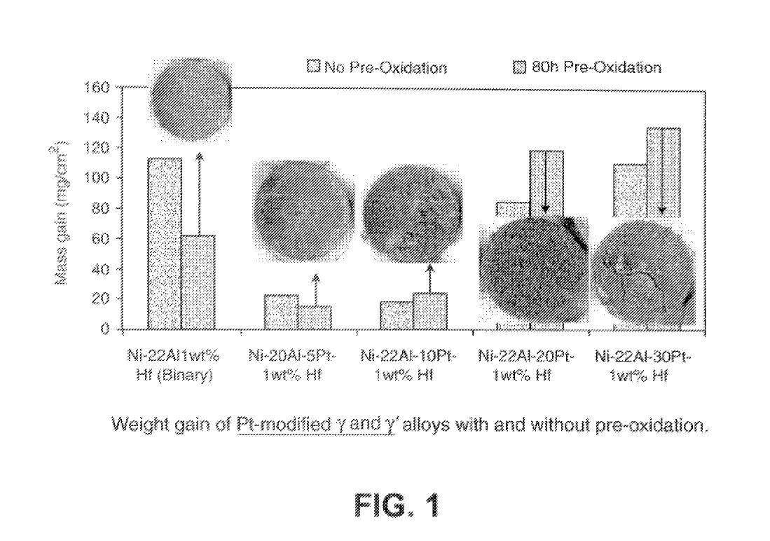

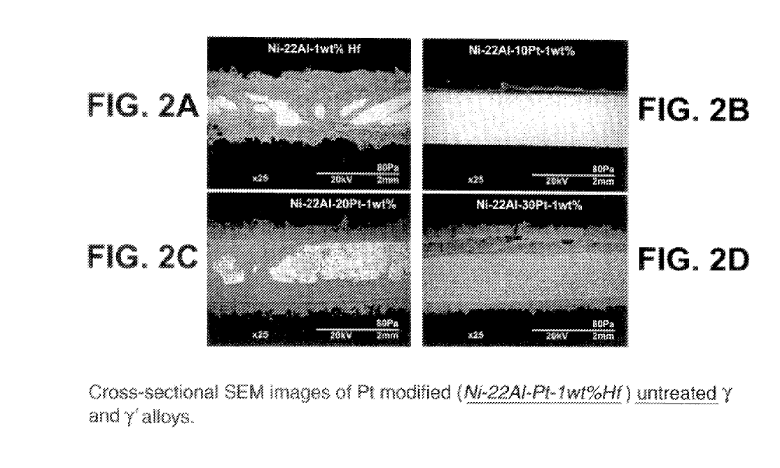

Various alloys were tested at 900° C. for 100 hours using a laboratory-scale Dean rig and with cool-down and Na₂SO₄ salt application after every 20 hours. The total weight gain and digital macro-images of Pt-modified γ+γ′ alloys after 100 hours of exposure is shown in FIG. 1. Addition of up to 10 at % of Pt to a base Ni-22Al-0.5Hf (All compositions are in atomic % unless stated otherwise, and 0.5 at. % Hf ˜1 wt. % Hf) decreased weight gain but for more % of Pt the weight gain increased. Cross-sectional SEM images of binary and Pt-modified γ and γ alloys are shown in FIG. 2. These images confirm that up to 10 at % Pt addition helped considerably to improve hot corrosion resistance of the alloys, but a higher amount of Pt addition (20 and 30 at %) was less effective against HTHC attack. While not wishing to be bound by any theory, this may be attributed to higher Ni₃S₂ formation with higher Pt content (above 10 at %). Pre-oxidation of the alloys for 80 hours in air at 1100° C. was beneficial only for the ternary and the low-Pt (5 at %) containing alloys.

### Example 2

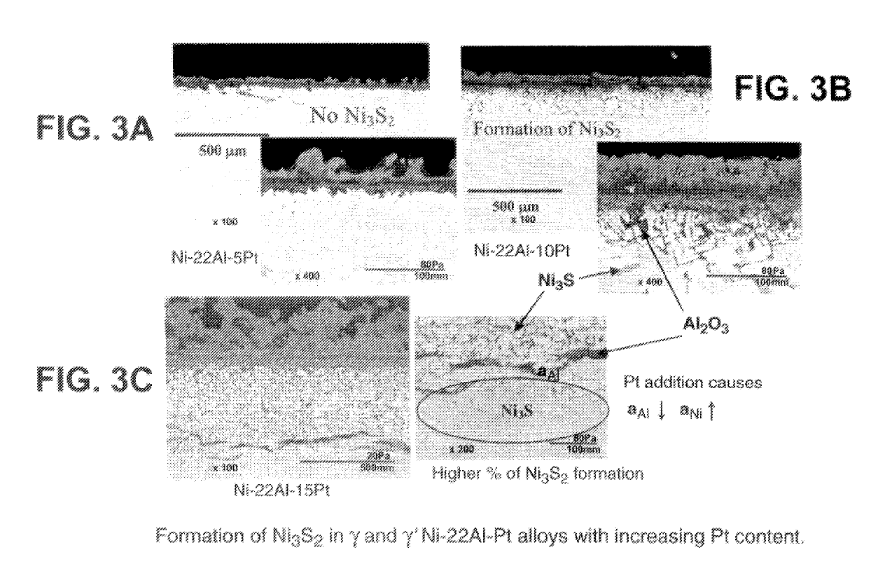

Electron probe microanalysis (EPMA) was used to analyze the phases formed during testing of various Pt-modified γ+γ′ alloys As shown in FIG. 3, it was found that internal precipitates of Ni₃S₂ formed extensively in the higher Pt containing alloys.

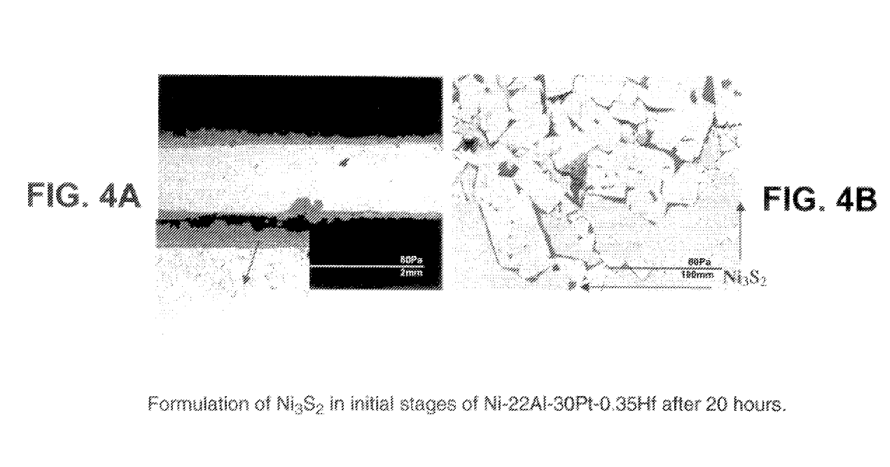

Although Al₂S₃ is more stable at 900° C., it should be noted that Pt addition decreases the chemical activity of Al (a_{Al}) and increases the chemical activity of Ni (a_{Ni}) favoring formation Ni₃S₂ at 900° C. Ni₃S₂ melts at 787° C. and causes liquidus attack at 900° C. The cross-sectional images of Ni-22Al-(5, 10 and 15 at %) Pt in FIG. 3 show a higher percentage of Ni₃S₂ formation with increase in Pt addition. Ni₃S₂ formation in Ni-22Al-30Pt-1 wt % Hf alloy was observed only after 20 hours of exposure (FIG. 4). Pre-oxidation of high Pt (20 and 30 at %) alloys further decreased a_{Al}, due to the formation of Al₂O₃ scale thereby favoring higher % Ni₃S₂ formation. Hence pre-oxidation of these alloys did not improve their HTHC resistance.

### Example 3

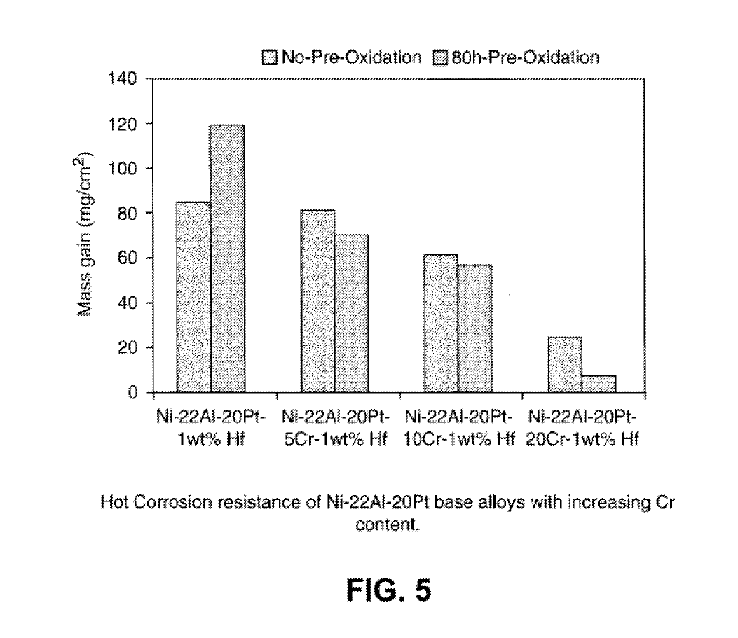

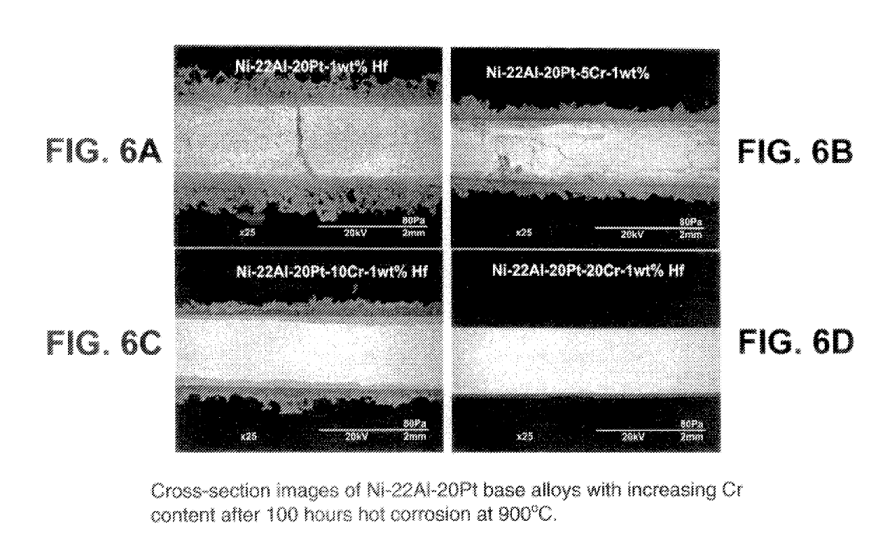

The addition of chromium to Pt-modified γ+γ′ and γ alloys further improves hot corrosion resistance. Experiments were carried on Ni-22Al-20Pt-1 wt % Hf with increasing Cr content from 0 to 20 at %. The weight gain of these alloys after 100 hours of hot-corrosion testing at 900° C. is shown FIG. 5. Addition of Cr improved hot corrosion resistance of these alloys and pre-oxidation of these alloys further helped to improve their hot corrosion resistance. The alloy with 20 at % Cr after pre-oxidation performed best and was not attacked even after 100 hours of exposure. Cross-sectional SEM images of pre-oxidized Ni-22Al-20Pt—Cr-1 wt % Hf alloys are shown in FIG. 6.

### Example 4

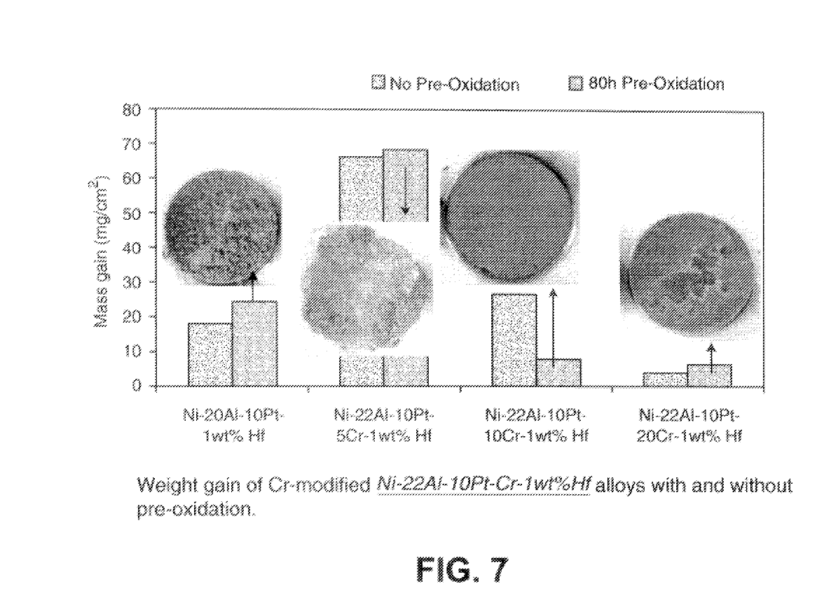

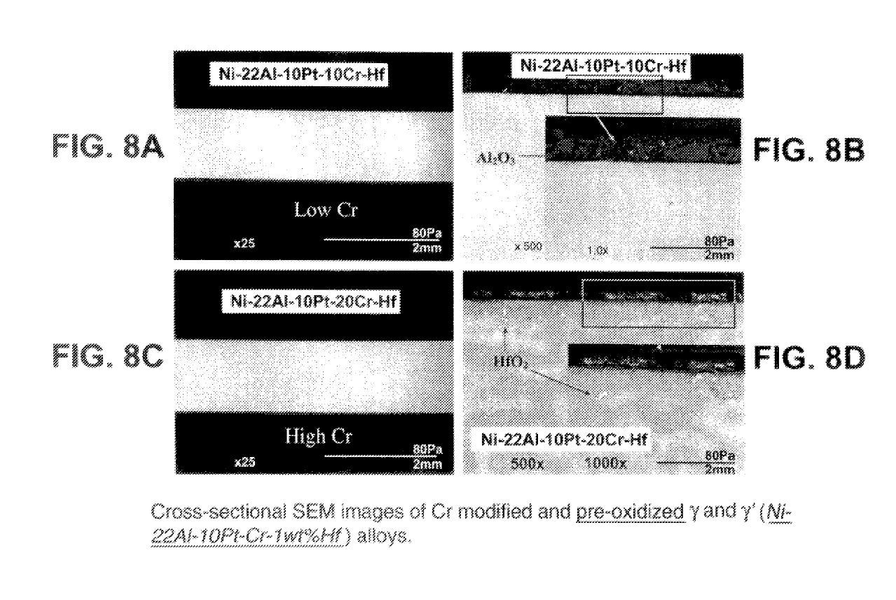

Chromium up to 20 at % was added to Ni-22Al-10Pt-1 wt % Hf containing γ+γ′ alloys. The weight gain in Cr modified-low Pt (γ and γ′) alloys is shown FIG. 7. Low Pt (10 at %) containing alloys with as low as 10 at % of Cr further improved hot corrosion resistance when pre-oxidized. Cross-sectional SEM images of pre-oxidized Ni-22Al-10Pt—Cr-1 wt % Hf alloys in FIG. 8 show that Ni-22Al-10Pt-10Cr-1 wt % Hf and Ni-22Al-10Pt-20Cr-1 wt % Hf had excellent hot corrosion resistance.

### Example 5

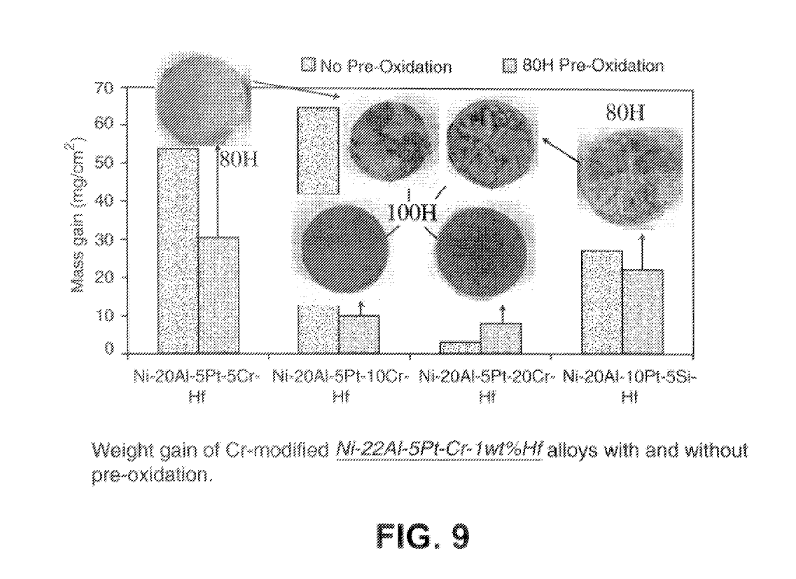

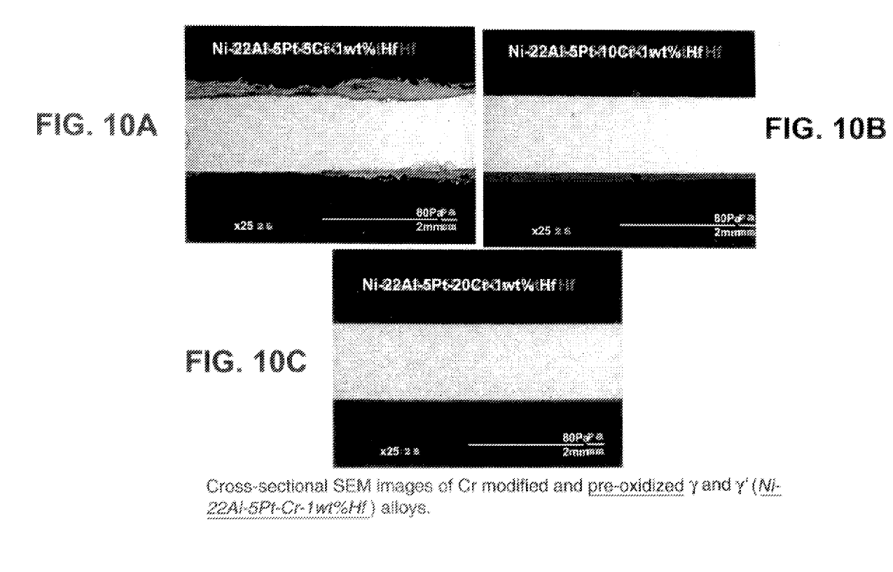

The weight gain of Ni-22Al-5Pt—Cr-1 wt % Hf (γ+γ′) alloys after 100 hours of hot corrosion at 900° C. is shown in FIG. 9. Cross-sectional SEM images of pre-oxidized Ni-22Al-5Pt—Cr-1 wt % Hf alloys in FIG. 10 show that Ni-22Al-5Pt-10Cr-1 wt % Hf and Ni-22Al-5Pt-20Cr-1 wt % Hf had excellent hot corrosion resistance.

### Example 6

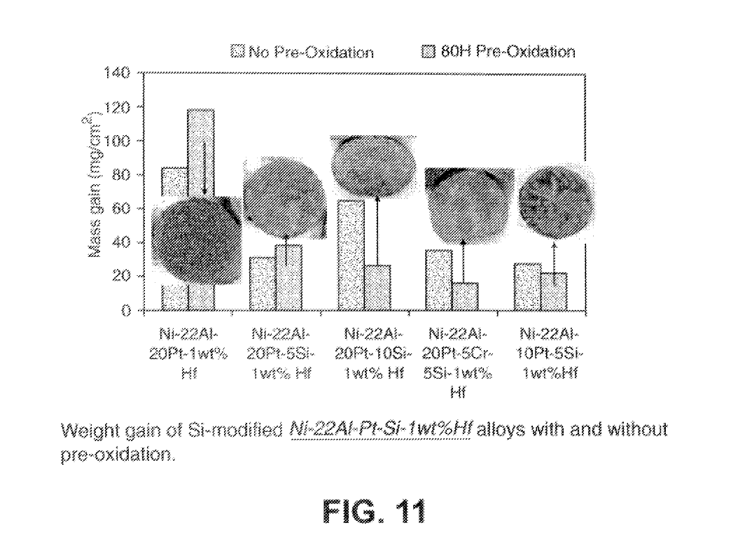

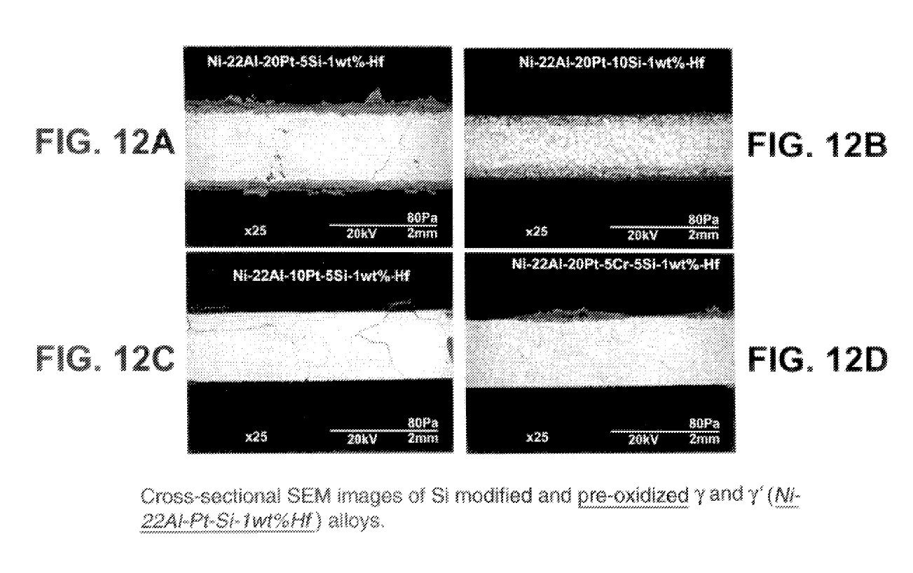

Addition of less than about 5 at % silicon is beneficial to the hot corrosion resistance of Pt-modified γ+γ′ alloys. However, addition of more than about 5 at. % silicon does not appear to be not beneficial. While not wishing to be bound by any theory, addition of increasing amounts of Si may leads to the formation of a phase with melting temperature of about 1165° C. The weight gain in Si-modified Ni-22Al—Pt—Si-1 wt % Hf alloys is shown in FIG. 11. Si modified Ni-22Al-10Pt-5Si-1 wt % Hf alloy and Si—Cr modified Ni-22Al-5Si-5Cr-1 wt % Hf show excellent hot corrosion resistance as shown in cross-sectional SEM images in FIG. 12.

### Example 7

### High Temperature Oxidation Resistance

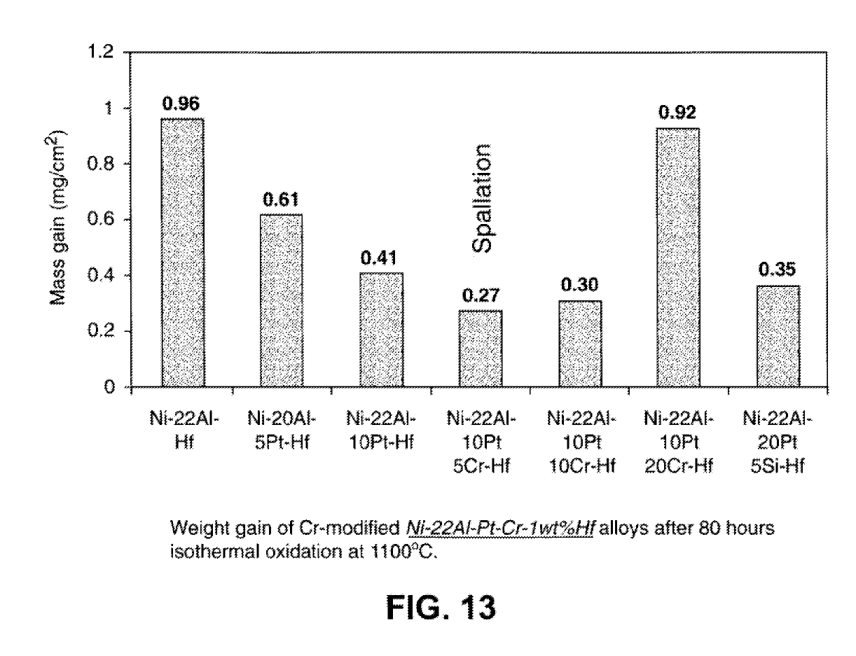

In addition to improving hot corrosion resistance, Cr and/or Si addition can improve the high-temperature oxidation resistance of Pt—Hf modified γ+γ and γ′ alloys. This beneficial effect is particularly evident for relatively low Pt containing alloys (i.e., 3-15 at. % Pt). The weight gain after isothermal oxidation (for 80 hours at 1100° C.) of Ni-22Al—Pt—Cr-1 wt % Hf alloys is shown in FIG. 13. Addition of 10 at % Cr in Ni-22Al-10Pt—Hf alloy improved its oxidation resistance. X-ray diffraction (XRD) analysis of the oxidized Ni-22Al-10Pt-10Cr-1 wt % Hf alloy indicated the formation of an exclusive scale layer of α-Al₂O₃. There was no indication of spinel (NiAl₂O₄) formation, which is found on the Ni-22Al-10Pt-1 wt % Hf alloy exposed to similar conditions. Similar kind of behavior is also observed in alloys with lower Cr content than Pt content. Adding silicon (5 at %) to Ni-22Al-20Pt—Hf also proved to be helpful in improving its oxidation resistance and XRD analysis of the oxidized specimen indicated the exclusive presence of Al₂O₃.

### Example 8

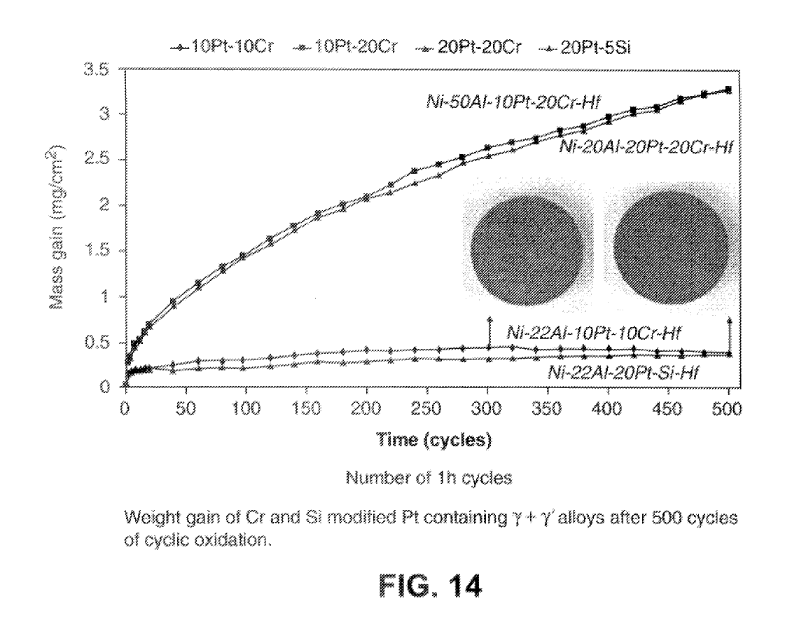

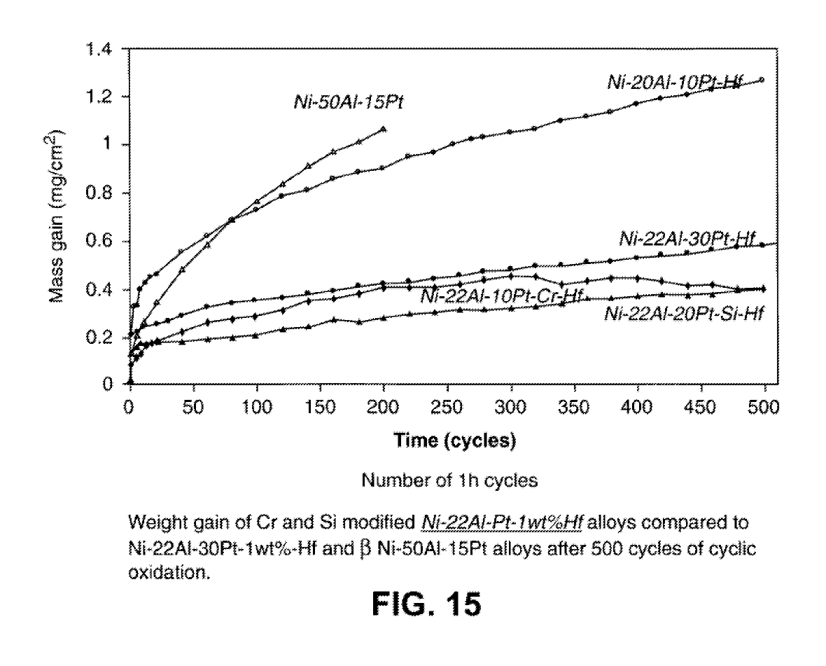

The cyclic oxidation behavior of some good hot corrosion resistant Cr- and Si-modified γ+γ′ alloys is shown in FIG. 14. Higher Cr addition (20 at %) in Pt containing γ+γ′ alloys did not show good oxidation resistance in this test and were internally oxidized. Chemical analysis performed on these alloys indicated formation of HfO₂ and Al₂O₃ internally. Cr and Si modified Pt containing γ+γ′ alloys are compared with the excellent oxidation resistant Ni-22Al-30Pt-1 wt % Hf and Pt modified β alloys in FIG. 15.

A number of embodiments of the invention have been described. Nevertheless, it will be understood that various modifications may be made without departing from the spirit and scope of the invention. Accordingly, other embodiments are within the scope of the following claims.

1-21. (canceled)

22. A coating on a substrate, wherein the coating is an alloy which comprises:
aluminum,
nickel,
at least one platinum group metal, wherein the alloy comprises less than about 10 at % of the at least one platinum group metal,
one or more of Cr, Ta, Si and Co, and
hafnium,
wherein the alloy consists essentially of gamma prime Ni₃Al phase and either beta NiAl phase or gamma Ni phase.

23. The coating of claim 22, wherein the alloy comprises about 0.5 at % to about 2 at % hafnium.

24. The coating of claim 22, wherein the coating has an outer surface region with a platinum group metal content of less than the average platinum group metal content in the coating.

25. The coating of claim 22, wherein the coating comprises about 10 at % to about 23 at % aluminum.

26. The coating of claim 22, wherein the coating comprises about 10 at % to about 22 at % aluminum.

27. The coating of claim 22, wherein the alloy comprises about 3 at % to less than about 10 at % of the at least one platinum group metal.

28. The coating of claim 22, wherein the coating consists essentially of the gamma prime Ni₃Al phase and the gamma Ni phase.

29. The coating of claim 22, wherein the coating has an innermost region with a platinum group metal content of greater than the average platinum group metal content in the coating.

30. The coating of claim 22, wherein the coating has an innermost region with an aluminum content of less than the average aluminum content in the coating.

31. The coating of claim 22, wherein the alloy comprises about 0.5 at % to about 1 at % halfnium.

32. The coating of claim 22, wherein the alloy is predominantly gamma prime Ni₃Al phase.

33. The coating of claim 22, wherein said coating is coated with a layer of ceramic.

34. The coating of claim 22, wherein the substrate is composed of a superalloy.

35. The coating of claim 22, wherein the substrate is a component for a gas turbine.

36. The coating of claim 22, wherein the coating is an overlay coating.

37. The coating of claim 22, wherein the balance of the coating is nickel.

38. The coating of claim 22, wherein the alloy comprises Cr.

39. The coating of claim 38, wherein the alloy comprises up to about 20 at % Cr.

40. The coating of claim 38, wherein the alloy comprises about 3 at % to about 20 at % Cr.

41. The coating of claim 22, wherein the alloy comprises Ta.

42. The coating of claim 22, wherein the alloy comprises Co.

43. The coating of claim 22, wherein the alloy comprises Si.

44. The coating of claim 43, wherein the alloy comprises up to about 7 at % Si.

45. The coating of claim 43, wherein the alloy comprises about 2 at % to about 7 at % Si.

46. The coating of claim 43, wherein the alloy comprises about 3 at % to about 5 at % Si.

47. The coating of claim 22, wherein the platinum group metal is Pt, Pd, Ir, Rh, Ru or a mixture thereof.

48. The coating of claim 22, wherein the at least one platinum group metal includes Pt.

49. A method of making the coating of claim 22, comprising applying the alloy on the substrate.

50. A coating on a substrate, wherein the coating is an alloy which comprises:
up to about 23 at % aluminum,
nickel,
at least one platinum group metal, wherein the alloy comprises less than about 10 at % of the at least one platinum group metal chromium or silicon, and
hafnium,
wherein
the alloy consists essentially of gamma prime Ni₃Al phase and either beta NiAl phase or gamma Ni phase, and
the gamma prime Ni₃Al phase is the predominant phase.

51. The coating of claim 50, wherein the coating comprises about 0.5 at % to about 2 at % hafnium.

52. The coating of claim 50, wherein the coating has an outer surface region with a platinum group metal content of less than the average platinum group metal content in the coating.

53. The coating of claim 50, wherein the coating comprises about 10 at % to about 23 at % aluminum.

54. The coating of claim 50, wherein the coating comprises about 10 at % to about 22 at % aluminum.

55. The coating of claim 50, wherein the alloy comprises about 0.5 at % to about 1 at % halfnium.

56. The coating of claim 50, which consists essentially of aluminum, nickel, the at least one platinum group metal, chromium or silicon, and about 0.5 at % to about 2 at % hafnium.

57. The coating of claim 50, wherein the platinum group metal is Pt, Pd, Ir, Rh, Ru or a mixture thereof.

58. The coating of claim 50, wherein the at least one platinum group metal includes Pt.

59. A method of making the coating of claim 50, comprising applying the alloy on the substrate.

60. A coating on a substrate, wherein the coating is an alloy which comprises:
aluminum,
nickel,
at least one platinum group metal, wherein the alloy comprises less than about 10 at % of the at least one platinum group metal,
one or more of Cr, Ta, Si and Co, and
hafnium,
wherein the alloy comprises gamma prime Ni₃Al phase and either beta NiAl phase or gamma Ni phase.

61. The coating of claim 60, wherein the alloy comprises about 0.5 at % to about 2 at % hafnium.

62. The coating of claim 60, wherein the coating has an outer surface region with a platinum group metal content of less than the average platinum group metal content in the coating.

63. A coating on a substrate, wherein the coating is an alloy which comprises:
up to about 23 at % aluminum,
nickel,
at least one platinum group metal, wherein the alloy comprises less than about 10 at % of the at least one platinum group metal
chromium or silicon, and
hafnium,
wherein
the alloy comprises gamma prime Ni₃Al phase and either beta NiAl phase or gamma Ni phase, and
the gamma prime Ni₃Al phase is the predominant phase.

64. The coating of claim 63, wherein the alloy comprises about 0.5 at % to about 2 at % hafnium.

65. The coating of claim 63, wherein the coating has an outer surface region with a platinum group metal content of less than the average platinum group metal content in the coating.
